(19) United States
(12) Patent Application Publication
(10) Pub. No.: US 2016/0341281 A1
(43) Pub. Date: Nov. 24, 2016

(54) SUBSEA GEAR TRAIN SYSTEM

(71) Applicant: ONESUBSEA IP UK LIMITED, London (GB)

(72) Inventors: Anders Brunvold, Blomsterdalen (NO); Hans Fredrik Kjellnes, Nesttun (NO); Asmund Valland, Bones (NO)

(21) Appl. No.: 14/715,514

(22) Filed: May 18, 2015

(51) Int. Cl. F16H 1/28; F04D 1/00; F04D 25/02; F04D 17/08; F04D 19/00; F04D 13/02; F16H 57/08; F04D 3/02

(52) U.S. Cl. CPC F16H 1/28; F16H 57/08; F04D 1/00; F04D 3/02; F04D 17/08; F04D 19/00; F04D 13/028; F04D 25/028

(57) ABSTRACT

According to some embodiments, a subsea fluid processing system is described that includes a subsea electric motor that rotates a motor shaft about a central axis. A subsea fluid processing machine driven by a second shaft being rotated about the central axis. A subsea gear train system includes a plurality of gears positioned in one or more at least partially or fully oil-filled volumes. The plurality of gears are configured and arranged to transmit power from the first shaft to the second shaft wherein one revolution of the first shaft causes greater than one revolution of the second shaft. In some examples the gear form an epicyclic gear train arrangement.

### TECHNICAL FIELD

The present disclosure relates to using subsea electric motors to drive subsea fluid processing equipment. More particularly, the present disclosure relates to electric motor driven gear train systems for subsea fluid processing equipment.

### BACKGROUND

In subsea fluid-processing applications such as subsea pumps and subsea compressors, the fluid processing equipment is typically directly driven by a subsea electric motor. In some cases a coupling is provided between the drive shaft of the electric motor and the shaft of the pump or compressor, so as to provide the ability to tolerate axial elongation and/or shrinkage. However, even in such cases the rotational speed of the load shaft of the pump or compressor is the same as the rotational speed of the electric motor drive shaft.

It is desirable to provide increasingly higher power and higher capacity subsea pumps and subsea compressors. It is also desirable to provide increasingly higher differential pressure for such rotating equipment. When working with a given speed range of a subsea electric motor, higher differential pressures and/or higher capacities can be obtained by increasing the diameter of the impeller elements of the pump or compressor. However, this can cause undesirable effects, such as increased loads on various components.

While subsea electric motors can be designed with higher speed capabilities, in many cases this is undesirable. For example, higher speed motor designs can suffer from greater viscous losses, as typical motors for subsea use are liquid filled and liquid cooled. Furthermore, in some cases there are significant efficiency losses in transmitting electric power at higher frequencies used to drive the motor at higher rpms.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to some embodiments, a subsea gear train system is described. The system includes a plurality of gears arranged and configured to transmit power from a first shaft driven by a subsea electric motor to a second shaft that drives a subsea fluid processing machine. The gearing is configured such that one revolution of the first shaft causes greater than one revolution of the second shaft.

According to some embodiments, the gears are positioned in one or more volumes each of which is partially filled with an oil. According to some embodiments the volume or volumes are completely filled with an oil. According to some embodiments, the oil has a viscosity grade of at most 32 centistokes at 40° C. According to some embodiments, the oil has a viscosity grade of at most 10 centistokes at 40° C.

According to some embodiments, the gears form an epicyclical gear train that includes: a sun gear having a plurality of teeth about an outer periphery; a plurality of (e.g. three, four, or more) planetary gears supported by a carrier, each having teeth about an outer periphery and positioned such that the teeth of each planetary teeth mesh with the teeth of the sun gear; and a non-rotating annular gear having a plurality of teeth about an inner periphery and positioned such that the teeth of the annular gear mesh with the teeth of each planetary gear. According to some embodiments, the plurality of gears are arranged and configured such that one revolution of the first shaft causes at least 1.5, 2 or 3 revolutions of the second shaft.

According to some embodiments, the subsea fluid processing machine is a subsea pump, such as a helico axial impeller pump or a centrifugal impeller pump. According to some other embodiments, the subsea processing machine is a subsea compressor. According to some embodiments the subsea processing machine is an electrical submersible pump.

According to some embodiments the sun gear, planetary gears and annular gear are straight-cut gears. According to some other embodiments the sun gear, planetary gears and annular gear are helical gears. The gears can be configured such that they generate an axial force that at least partially counteracts an axial force on the second shaft generated during operation of the fluid processing machine. According to some embodiments, the gear train includes pairs of helical gears configured such that axial forces generated by the helical gears tend to counteract each other. According to some embodiments, first shaft and the carrier include one or more conduits configured to carry cooled lubricating barrier fluid towards bearing surfaces for each of the plurality of planetary gears.

According to some embodiments, a subsea fluid processing system is described that includes: a subsea electric motor configured to rotate a first shaft about a central axis; a subsea fluid processing machine driven by a second shaft being rotated about the central axis; and a subsea gear train system including a plurality of gears positioned in one or more at least partially oil-filled volumes, the plurality of gears being configured and arranged to transmit power from the first shaft to the second shaft wherein one revolution of the first shaft causes greater than one revolution of the second shaft. According to some embodiments, the one or more at least partially oil-filled volumes are completely filled with oil.

According to some embodiments an electrical submersible pump system is described that includes: a submersible electric motor configured to rotate a first shaft about a central axis; a submersible pump driven by a second shaft being rotated about the central axis; and a submersible gear train system including a plurality of gears positioned in one or more at least partially oil-filled volumes, the plurality of gears being configured and arranged to transmit power from the first shaft to the second shaft wherein one revolution of the first shaft causes greater than one revolution of the second shaft. According to some embodiments, the one or more at least partially oil-filled volumes are completely filled with oil.

According to some embodiments, a method of driving a subsea fluid processing machine is described that includes: powering a subsea electric motor that applies torque to and thereby rotates a first shaft; and transmitting power using a gear train system from the first shaft to a second shaft that drives the subsea fluid processing machine. The gear train system includes a plurality of gears arranged and configured such that one revolution of the first shaft causes greater than one revolution of the second shaft.

According to some embodiments, one or more of the described systems and/or methods can be used in topside or subsea fluid processing equipment in an analogous fashion.

### BRIEF DESCRIPTION OF THE DRAWINGS

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1 is a diagram illustrating a subsea environment in which a subsea gear train system can be deployed, according to some embodiments;

FIG. 2 is a diagram illustrating a subsea pumping or compressor module in which a subsea gear train system can be deployed, according to some embodiments;

FIG. 3 is a diagram illustrating further details of a subsea pumping or compressor module in which a subsea gear train system can be deployed, according to some embodiments;

FIG. 4 is a diagram illustrating further details of a subsea gear train system, according to some embodiments;

FIG. 5 is a diagram illustrating aspects of an epicyclic gear train arrangement used in a subsea gear train system, according to some embodiments; and

FIG. 6 is a diagram illustrating aspects of a helical gear train arrangement used in a subsea gear train system, according to some embodiments.

### DETAILED DESCRIPTION

The particulars shown herein are by way of example, and for purposes of illustrative discussion of the embodiments of the subject disclosure only, and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Further, like reference numbers and designations in the various drawings indicate like elements. In the following discussion and in the claims, the terms “including” and “comprising” are used in an open-ended fashion, and thus should be interpreted to mean “including, but not limited to . . . .” Also, the term “subsea” and “submersible” shall be considered alike and intended to mean either under the sea surface or downhole. As such, for example, “a subsea fluid processing” machine can be installed on any location between the sea floor and the sea surface or on any subterranean location, for example inside an oil or gas well.

Pump and compressors comprise a motor and a pump/compressor portion. In some embodiments, the motor and the overall lubrication system might be 100% liquid filled. The oil is circulated around the motor internals, and the pump or compressor bearings and seals to lubricate and cool vital parts of the machine. This cooling and lubrication system is often described as the barrier fluid system. In typical rotating equipment such as pumps and compressors, an overpressure is often applied in the barrier fluid system versus to keep the rotating equipment internals clean at all times and to avoid any processing fluid intrusion.

In the current commercial setting, it is desirable to provide higher power and higher capacity in pumps and compressors. It is also desirable to provide rotating equipment (such as pumps and compressors) that has higher differential pressures. According to some embodiments, a gear train system such as a planetary gearbox is provided between the electric motor and the pump and/or compressor. The gear train system can be configured to achieve higher capacity and higher efficiencies especially for a helico axial impeller pumps, such as used in multiphase pumps/compressors, as centrifugal impeller pumps, such as used in single phase pumps/compressors. It is also desirable to provide a subsea electric motor that has lower rates of barrier fluid viscous losses, which can be achieved by tuning the motor and power supply system to provide better efficiency at lower rpms.

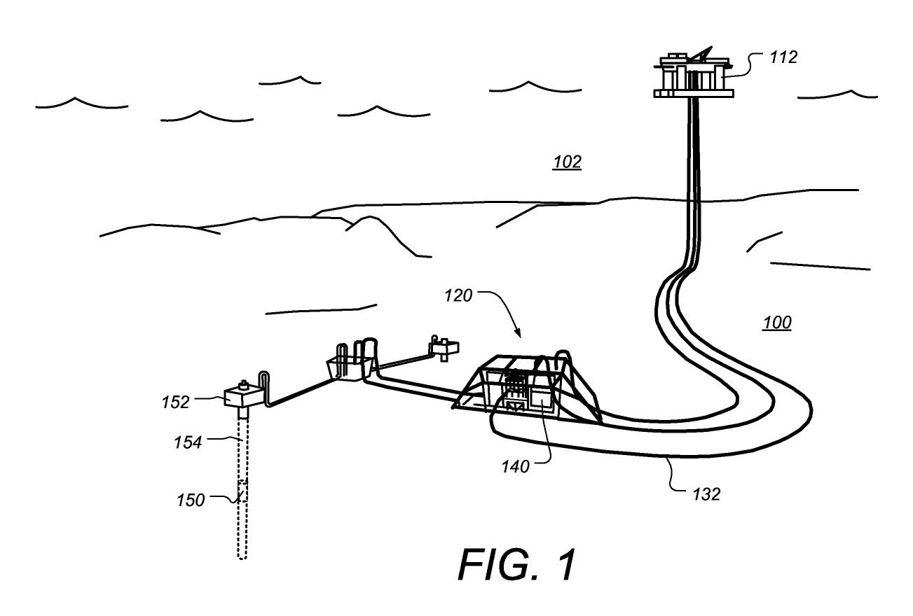

FIG. 1 is a diagram illustrating a subsea environment in which a subsea gear train system can be deployed, according to some embodiments. On sea floor 100 a subsea station 120 is shown which is downstream of several wellheads being used, for example, to produce hydrocarbon-bearing fluid from a subterranean rock formation. Station 120 includes a subsea pumping module 140, which is powered by an electric motor, such as an induction motor or permanent magnet motor. The station 120 is connected to one or more umbilical cables, such as umbilical 132. The umbilicals in this case are being run from a platform 112 through seawater 102, along sea floor 100 and to station 120. In other cases, the umbilicals may be run from some other surface facility such as a floating production, storage and offloading unit (FPSO), or a shore-based facility. The umbilical 132 can also be used to supply barrier and other fluids, and control and data lines for use with the subsea equipment in station 120. Although a pumping module 140 is shown in FIG. 1, according to some embodiments the module 140 can be configured for other subsea fluid processing functions, such as a subsea compressor module and/or a subsea separator module. In all embodiments described herein, it is understood that references to subsea pumps and pumping modules can alternatively refer to subsea compressors and compressor modules. Furthermore, references herein to subsea pumps and subsea compressors should be understood to refer equally to subsea pumps and compressors for single phase liquids, single phase gases, or multiphase fluids. According to some embodiments, the subsea gear train system described herein is used in connection with a electrical submersible pump (ESP) 150 which can either be located downhole, as shown wellbore 154 in FIG. 1 or it can be located in a subsea location such as on the sea floor in a christmas tree at wellhead 152 or other equipment. Thus in all embodiments described herein, it is understood that references to subsea pump and pumping modules can alternatively refer to ESPs whether deployed downhole or in a subsea location.

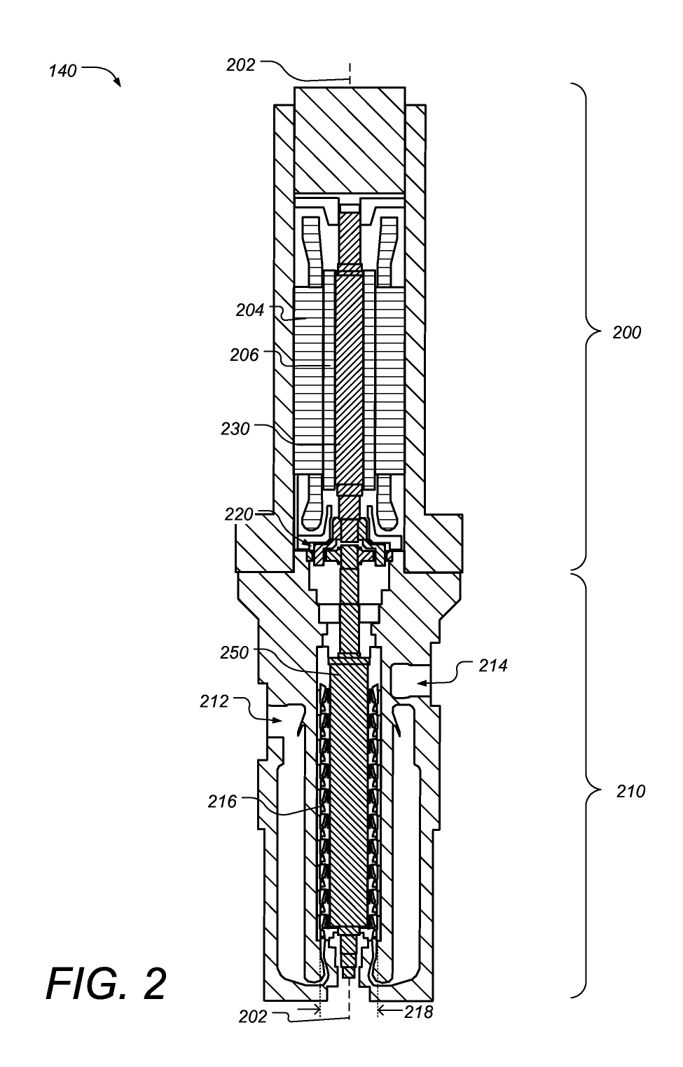

FIG. 2 is a diagram illustrating a subsea pumping module in which a subsea gear train system can be deployed, according to some embodiments. Portions of pumping module 140 is shown, including subsea electric motor 200 and subsea pump 210. Motor 200 is filled with an insulating lubricating oil, or other barrier fluid, that is supplied via an umbilical from the surface (as shown in FIG. 1). According to some embodiments, motor 200 also includes a circumferentially arranged barrier fluid cooling coil, not shown. Motor 200 includes stator 204 and rotor 206, which act to rotate the rotor 206 and motor shaft about central axis 202. Subsea gear train system 220 transmits the rotation of motor shaft 230 to rotation of pump shaft 250. According to some embodiments, the gear train system 220 is configured with a gear ratio of less than unity such that the pump shaft 250 revolves faster than the motor shaft 230. In the subsea pump 210, the pump shaft drives a plurality of vertically stacked impeller stages 216. In a pump arrangement such as shown in FIG. 2, fluid enters from pump inlet 212 and travels upwards though each successive impeller stage that increases fluid pressure and exits via pump outlet 214.

It has been found that by providing a gear train system such as system 220 the motor 200 can be run at lower rpms. This results in lower barrier fluid viscous losses in motor 200. Additionally, operating motor 200 at lower rpms allows for increased power transmission efficiency associated with lower frequency electric supply power that is transmitted via umbilical cabling such as umbilical 132 in FIG. 1. This can be significant especially for longer step out distances without using transformers at a given power cable cross section. Additionally, other benefits can be achieved such as increased power system flexibility. Finally, by using a gear train system such as system 200, higher differential pressures and/or higher capacity flow rates can be obtained from the pump for a given pump diameter (e.g. pump diameter 218 shown in FIG. 2). While higher pressures and/or higher capacities can be obtained by increasing the designed diameter of the impeller elements of the pump or compressor, larger diameter designs have other problems such as increased loads on bearings and seals. Thus, by providing a gear train system, the pump design can be optimized to run at higher rpm ranges while the motor and power transmission systems can be optimized to run at lower rpms ranges.

While gearboxes designed for surface applications typically make use of relatively high viscosity oil, such as oils optimized for air-filled gear transmissions, a design goal in subsea applications is to provide a gearbox that is robust using relatively low viscosity oil. This is because in subsea applications the gear train is completely or nearly completely surrounded by oil and using high viscosity oil may increase losses to a point where other efficiency benefits of the gear train are outweighed.

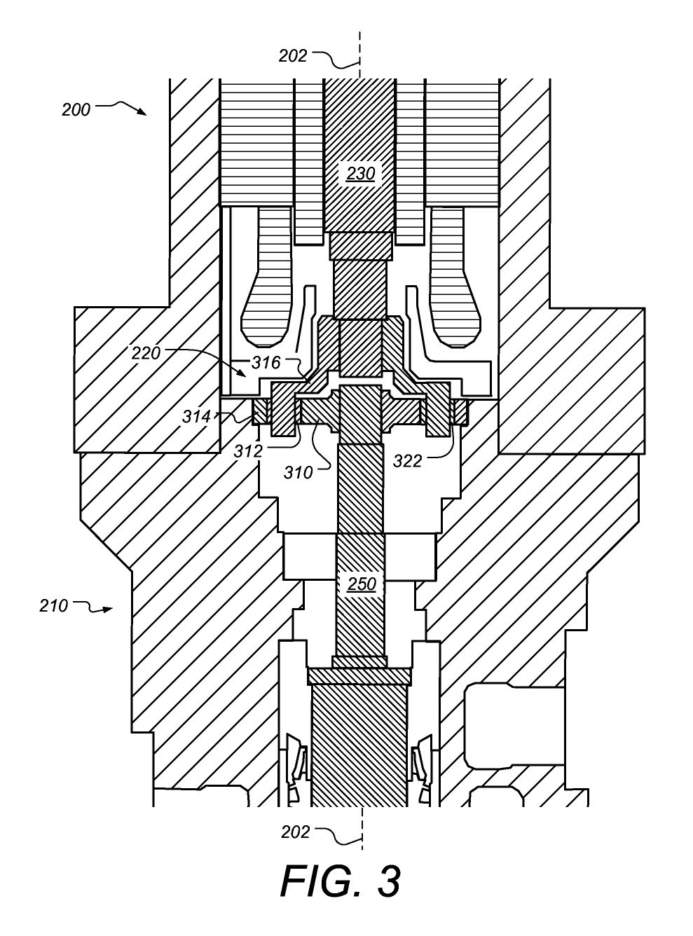

FIG. 3 is a diagram illustrating further details of a subsea pumping module in which a subsea gear train system can be deployed, according to some embodiments. As shown the example of FIG. 3, gear train system 220 can be an epicyclic gear train arrangement. Sun gear 310 is fixed to pump shaft 250. Ring gear 314 is fixed to the housing of the pump module—in this case to the housing of pump 210. Both sun gear 310 and ring gear 314 are concentric about the central axis 202. A carrier 316 carries, via bearings, a plurality of planet gears, of which two gears 312 and 322 are visible in FIG. 3. The carrier 316 is fixed to the motor shaft 230 such that each of the planet gears rolls around the sun gear 310. According to some embodiments, the epicyclic gear train arrangement shown in FIG. 3 can replace an existing simple gear coupling that exists between a motor and pump or compressor, and can allow for the same tolerances of axial shaft expansion.

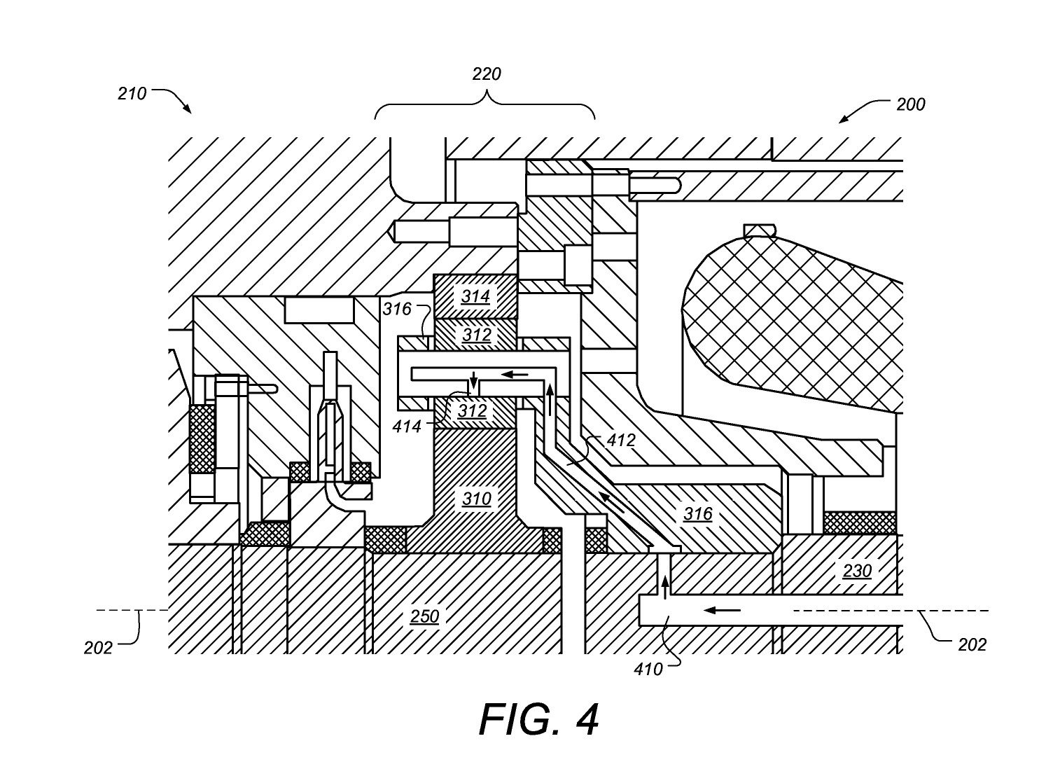

FIG. 4 is a diagram illustrating further details of a subsea gear train system, according to some embodiments. Gear train system 220, in the example shown in FIG. 4 is also an epicyclic gear train arrangement with sun gear 310, planet gear 312, ring gear 314, and carrier 316. Note that while only one planet gear 312 is shown in FIG. 4 for clarity, greater numbers of planet gears are provided according to some embodiments. In some embodiments three, four or more planet gears are provided. In the example shown in FIG. 4, the planet gears are fitted with bearings to which cooled and overpressurized oil is fed. Oil is supplied from a source of cooled higher pressure oil located near the top of the motor. The cooled pressurized oil travels through conduit 410 in shaft 230 and through conduit 412 in carrier 316. The oil exits to the bearing via orifice 414.

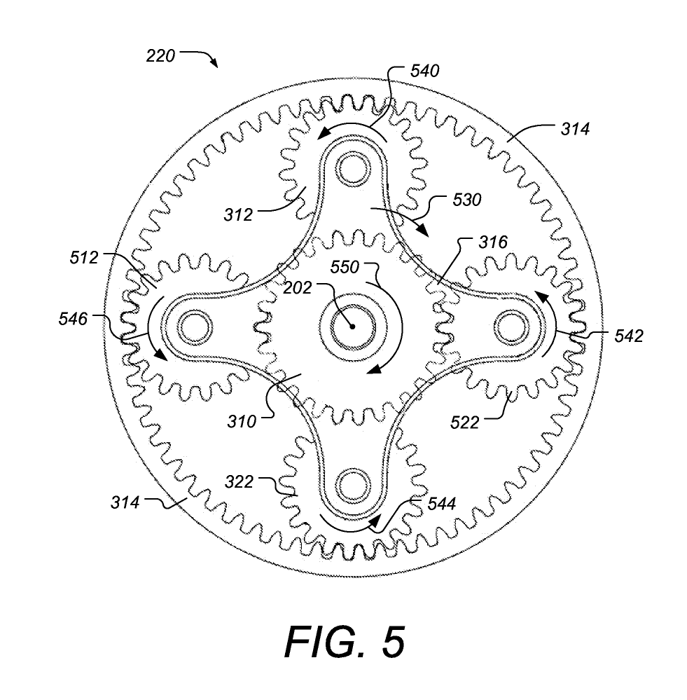

FIG. 5 is a diagram illustrating aspects of an epicyclic gear train arrangement used in a subsea gear train system, according to some embodiments. In this example, the gear train system 220 includes four planet gears 312, 322, 512 and 522. The planet gears roll around the central sun gear 310. According to other embodiments, other numbers of planet gears, such as 3, 5, 6, 7 or 8 can be provided. Note that as carrier 316 is rotated by motor shaft 230 (not shown), in the direction of arrow 530, each of the planet gears 312, 522, 322 and 512 will rotate about their own axes as shown by arrows 540, 542, 544 and 546, respectively. Note that each of the planet gears also revolves about the central axis 202, although this is not shown by the arrows. The sun gear will rotate about axis 202 as shown by arrow 550. According to some embodiments, the gear train system 220 is configured with a gear ratio of less than unity such that the carrier 316 rotates about axis 202 at a slower rate than sun gear 310. Thus the output speed to the pump is greater than the input speed provided by the motor.

Subsea pumps and subsea compressors typically have strict tolerances for vibration levels. According to some embodiments, the sun, planet and ring gears in the gear train 220 are helical gears, which create less vibration in a gearbox when compared to straight gears. According to some embodiments, mechanical couplings can be provided on either side, or both sides, of the system 220 purposes.

Using helical gears can generate axial forces that, according to some embodiments, can be designed to counter-balance other known axial forces in the system. For example, in FIG. 2 the pump 210 will exert a downwards force on the pump shaft 250 as the impeller stages accelerate the fluid upwards. Helical gears in system 220 can be designed to partially counteract such downward force. According to some embodiments, other techniques such as the use of thrust bearings on the pump and/or motor shafts can be employed to accommodate axial forces generated by the helical gearing. Engineering to balance axial forces can be done several ways.

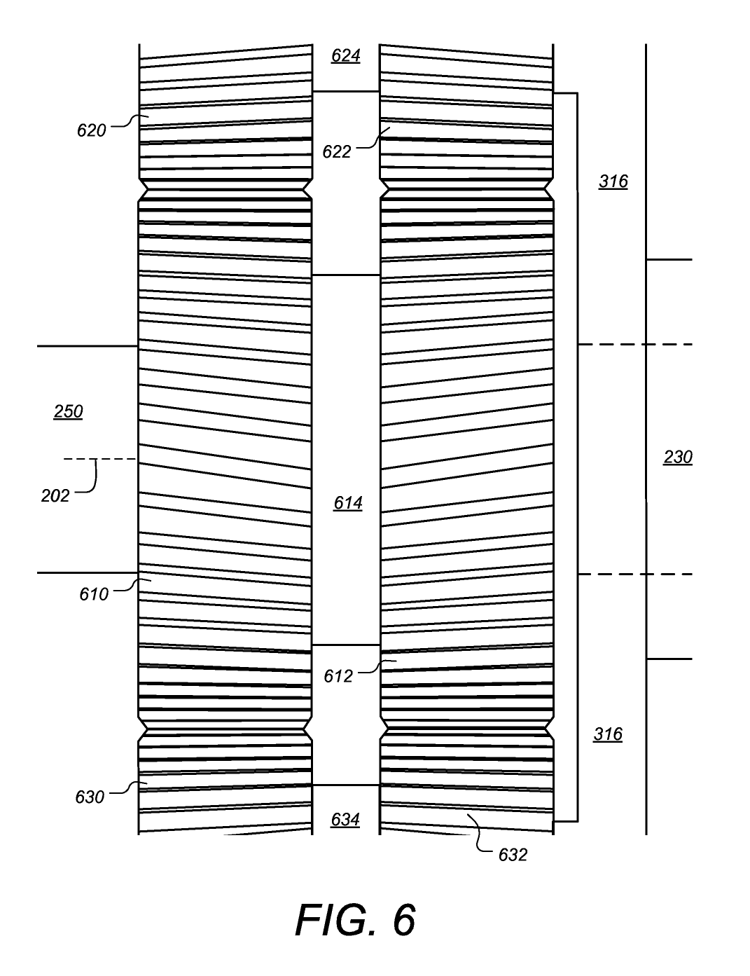

FIG. 6 is a diagram illustrating aspects of a helical gear train arrangement used in a subsea gear train system, according to some embodiments. In this example, each helical gear is doubled. There are two sun gears 610 and 612, and two of each planet gears (pairs 620/622 and 630/632 are visible in FIG. 6). There are also two ring gears, not shown. Each pair of gears is fixed via carriers (such as carriers 614, 624 and 634). The doubling arrangement shown in FIG. 6 allows for axial force balancing. The net axial force can be designed to be zero (or nearly zero) or, according to some embodiments, the net axial force can be designed to beneficially counteract the axial force generated by the pump. Another alternative to the arrangement shown in FIG. 6 is to use double-helical or herringbone gears.

While the subject disclosure is described through the above embodiments, it will be understood by those of ordinary skill in the art that modification to and variation of the illustrated embodiments may be made without departing from the inventive concepts herein disclosed. Moreover, while some embodiments are described in connection with various illustrative structures, one skilled in the art will recognize that the system may be embodied using a variety of specific structures. Accordingly, the subject disclosure should not be viewed as limited except by the scope and spirit of the appended claims.

What is claimed is:

1. A subsea gear train system comprising a plurality of gears arranged and configured to transmit power from a first shaft driven by a subsea electric motor to a second shaft that drives a subsea fluid processing machine, wherein one revolution of said first shaft causes greater than one revolution of said second shaft.

2. A system according to claim 1 wherein said plurality of gears are positioned in one or more volumes each of which is at least partially filled with an oil.

3. A system according to claim 2 wherein said one or more volumes are completely filled with the oil.

4. A system according to claim 1 wherein said plurality of gears forms an epicyclical gear train comprising:
a sun gear having a plurality of teeth about an outer periphery and positioned in axial alignment with a central axis of said electric motor and of said subsea fluid processing machine;
a plurality of planetary gears supported by a carrier, each having teeth about an outer periphery and positioned such that said teeth of each planetary teeth mesh with the teeth of said sun gear; and
a non-rotating annular gear having a plurality of teeth about an inner periphery and positioned such that the teeth of the annular gear mesh with the teeth of each planetary gear.

5. A system according to claim 4 wherein said plurality of planetary gears includes at least three planetary gears.

6. A system according to claim 5 wherein said plurality of planetary gears includes at least four planetary gears.

7. A system according to claim 1 wherein said plurality of gears are arranged and configured to such that one revolution of said first shaft causes at least one of 1.5, 2 or 3 revolutions of said second shaft.

8. A system according to claim 1 wherein said subsea fluid processing machine is a subsea pump.

9. A system according to claim 8 wherein said subsea pump is taken from the list consisting of: a helico axial impeller pump, a centrifugal impeller pump and an electrical submersible pump.

10. A system according to claim 1 wherein said subsea fluid processing machine is a single phase compressor or a multiphase compressor.

11. A system according to claim 1 wherein said subsea fluid processing machine is configured to process fluid produced from a hydrocarbon bearing subterranean reservoir.

12. A system according to claim 4 wherein said sun gear, planetary gears and annular gear are helical gears or straight-cut gears.

13. A system according to claim 12 wherein said sun gear, planetary gears and annular gear are helical gears that are configured such that a first axial force generated by the helical gears at least partially counteracts a second axial force on the second shaft generated during operation of the fluid processing machine.

14. A system according to claim 12 wherein said sun gear, planetary gears and annular gear are helical gears and said epicyclical gear train further comprises a second sun gear and a second plurality of planetary gears that are helical gears and configured such that axial forces generated by the helical gears tend to counteract each other.

15. A system according to claim 4 wherein said first shaft and said carrier include one or more conduits configured to carry cooled lubricating barrier fluid towards bearing surfaces for each of said plurality of planetary gears.

16. A subsea fluid processing system comprising:
a subsea electric motor configured to rotate a first shaft about a central axis;
a subsea fluid processing machine driven by a second shaft being rotated about the central axis; and
a subsea gear train system including a plurality of gears positioned in one or more at least partially oil-filled volumes, the plurality of gears being configured and arranged to transmit power from the first shaft to the second shaft wherein one revolution of said first shaft causes greater than one revolution of said second shaft.

17. An electrical submersible pump system comprising:
a submersible electric motor configured to rotate a first shaft about a central axis;
a submersible pump driven by a second shaft being rotated about the central axis; and
a submersible gear train system including a plurality of gears positioned in one or more at least partially oil-filled volumes, the plurality of gears being configured and arranged to transmit power from the first shaft to the second shaft wherein one revolution of said first shaft causes greater than one revolution of said second shaft.

18. A system according to claim 17 wherein said one or more at least partially oil filled volumes are completely filled with oil.

19. A system according to claim 17 wherein said plurality of gears form an epicyclical gear train comprising:
a sun gear having a plurality of teeth about an outer periphery and positioned in axial alignment with the central axis;
a plurality of planetary gears supported by a carrier, each having teeth about an outer periphery and positioned such that said teeth of each planetary teeth mesh with the teeth of said sun gear; and
a non-rotating annular gear having a plurality of teeth about an inner periphery and positioned such that the teeth of the annular gear mesh with the teeth of each planetary gear.

20. A system according to claim 17 wherein the system is configured for deployment a wellbore.

21. A method of driving a subsea fluid processing machine comprising:
powering a subsea electric motor that applies torque to and thereby rotates a first shaft; and
transmitting power using a gear train system from said first shaft to a second shaft, the second shaft driving the subsea fluid processing machine, the gear train system including a plurality of gears arranged and configured such that one revolution of said first shaft causes greater than one revolution of said second shaft.

22. A method according to claim 21 wherein said plurality of gears are positioned in one or more volumes each of which is at least partially filled with an oil.

23. A method according to claim 21 wherein said plurality of gears form an epicyclical gear train comprising:
a sun gear having a plurality of teeth about an outer periphery and positioned in axial alignment with a central axis of said electric motor and of said subsea fluid processing machine;
a plurality of planetary gears supported by a carrier, each having teeth about an outer periphery and positioned such that said teeth of each planetary teeth mesh with the teeth of said sun gear; and
a non-rotating annular gear having a plurality of teeth about an inner periphery and positioned such that the teeth of the annular gear mesh with the teeth of each planetary gear.
